(19) United States
(12) Patent Application Publication
(10) Pub. No.: US 2011/0137770 A1
(43) Pub. Date: Jun. 9, 2011

(54) ELECTRONIC CHECKBOOK AND REGISTER

(76) Inventor: VICKIE GLASCO, Cobden, IL (US)

(21) Appl. No.: 12/632,622

(22) Filed: Dec. 7, 2009

(51) Int. Cl. G06Q 40/00

(52) U.S. Cl. 705/33

(57) ABSTRACT

An electronic checkbook for recording and monitoring transactions comprising: a booklet of checks, where said checks are positioned at the lower half of the checkbook; an electronic device, where said electronic device provides a mechanism to store, record and scan receipts, to record transactions related to a plurality of accounts and to display data related to the transactions and the plurality accounts; a power supply, where said power supply supplies power to the electronic device. The mechanism to scan receipts may include a pin scanner connected to the electronic device. In terms of displays, the electronic device may include a display for displaying the results of a scanned document using the pin scanner. The electronic device may include a statement display that displays the information related to the plurality of accounts. The electronic device includes at least one processor, memory and software to execute functions related to the electronic device.

### BACKGROUND OF THE INVENTION

1. Field of Invention

The present invention relates to an electronic checkbook and register that provides a means to register and keep track of transactions related personal bank accounts.

2. Description of Related Art

Many individuals maintain personal banking accounts such savings or checking accounts. The checking account provides a means for individuals to pay bills, debts and to execute transactions. As a means of executing transactions, an account holder usually uses a checkbook. The conventional checkbook includes preprinted checks in numerical order that include the check owner's name, bank account number and a bank routing number associated with the bank. The checkbook usually includes a handwritten ledger that is attached to the top flap of the checkbook that provides a means for the user to register each check as it is written. Recent technical developments have witnessed the creation of various electronic accessories and checkbooks that may be used by individuals as a replacement for the traditional checkbook. Methods of providing electronic accessories or computerizing the traditional checkbook include the addition of a simple calculator and small electronic check registries within the checkbook. U.S. Pat. No. 5,233,547 discloses an electronic checkbook that comprises a lower part, a booklet of checks, and a digitizer affixed to the reminder of the lower part that operates as a keyboard in one mode when placed above the checkbook and then can be placed beneath the top of the checkbook and used in a second mode as a means for inputting signals to the remainder of the device representing information written on the check. The upper part includes a display screen upon which the checking account information appears during use of the electronic checkbook where the checkbook records a record of transactions in the checking account in addition to deposits and subtractions of checks drawn on the account.

Although various electronic devices have been developed with relation to checkbooks and the use of conventional checkbook devices there still remains a need for further development of this field of art. Some of the shortcomings associated with the electronic checkbooks of prior art include the inability to actually record receipts that may be associated with transactions made from a checking account and to accommodate for debit charges due to the wide use of debit cards.

### SUMMARY OF THE INVENTION

The present invention relates to an electronic checkbook for recording and monitoring transactions comprising: a booklet of checks, where said checks are positioned at the lower half of the checkbook; an electronic device, where said electronic device provides a means to store, record and scan receipts, to record transactions related to a plurality of accounts and to display data related to the transactions and the plurality accounts; a power supply means, where said power supply means supplies power to the electronic device. The means to scan receipts may include a pin scanner connected to the electronic device. In terms of displays, the electronic device may include a display for displaying the results of a scanned document using the pin scanner. The electronic device may also include a statement display that displays the information related to the plurality of accounts. The electronic device includes at least one processor, memory and software to execute functions related to the electronic device.

### BRIEF DESCRIPTION OF DRAWINGS

FIG. 1 depicts an overview of the electronic checkbook according to the present invention.

### DETAILED DESCRIPTION

The present invention provides an electronic checkbook and registry that assists a user in electronically recording each transaction related to selected individual banking accounts. The electronic checkbook according to the present invention further provides a means to scan and record receipts that may be associated with transactions that take place through the accounts monitored by the electronic checkbook. The scanning pen associated with the electronic checkbook scans receipts that may be associated with debit transactions that will not necessarily require the drafting of a check but however affect the balance of the checking account. Further deposits may be recorded and a savings account may be monitored through the use of the electronic checkbook according to the present invention.

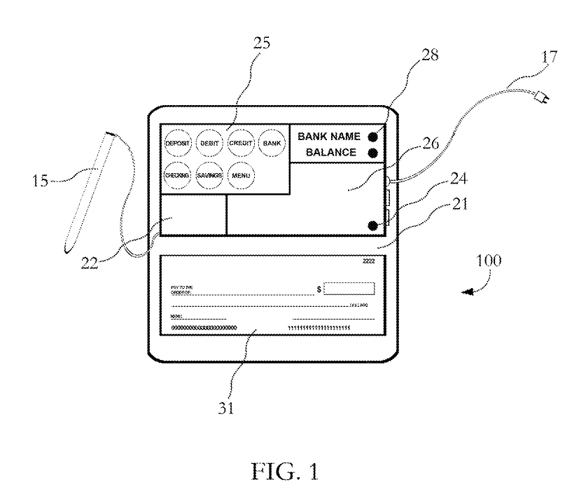

FIG. 1 depicts an electronic checkbook according to the present invention. The electronic checkbook 100 includes a booklet of checks 31 that is usually associated with a conventional checkbook. The booklet of checks 31 may be positioned in the lower half of the electronic checkbook 100. The top half of the electronic checkbook 100 is an electronic device that provides a means to store, record and scan receipts related to the accounts being monitored. A power supply may also extend from the electronic device of the checkbook 100. Two displays are included in the checkbook 100, a statement display 22 is shown with a display 26. The display 26 provides a means to display the resulting scanned receipt or document that is scanned by a pin scanner 15. The pin scanner 15 provides a means to scan receipts or other documents that may be related to the checking account or savings account that is being monitored through the electronic checkbook 100. Once a receipt or document is scanned using the scanning pin 15, the results and images may be shown in display 26. Internally within the electronic device of the checkbook 100, at least one processor, memory and appropriate software is provided to execute the functions associated with the displays 22, 26, pin scanner 15 and further input devices described below.

The electronic checkbook 100 is provided power via a battery 21 that may be recharged through a charging connection 17. The charging connection 17 connects to the electronic checkbook 100 and may charge the battery 21 by connecting to an AC outlet. In an alternative embodiment of the present invention, the electronic checkbook is charged by connecting directly to a computer that charges the electronic checkbook but also provides a means to sync data that may be stored on memory in the electronic checkbook with data that may be stored in the memory of the associated computer. The alternative embodiment provides a means to backup data stored on the electronic checkbook 100 on a computer hard drive and then sync this information with software that may be provided on the computer.

Another feature provided by the electronic checkbook 100 include a series of input buttons 25. The input buttons provide a way to designate the transaction as a deposit, debit, credit and to designate the associated account, checking or savings. It is further contemplated that the electronic checkbook 100 may be capable of managing and storing transactions related to a plurality of accounts at multiple banks or multiple accounts at a single bank. Suitable functionality is provided by the input panel 25 and the display 28 provides an electronic display of the bank name, checking account name and balance associated with the account. Further indicators may be provided that include a low balance warning that may be preset by the user. Further a battery indicator 24 is provided that indicates if a low battery has developed and that the electronic checkbook needs to be charged.

The electronic checkbook 100 provides a portable electronic check registry and bank account data storage device. The electronic checkbook 100 assists the user in keeping an accurate balance of one's banking accounts, storing receipts and avoiding overdraft fees through preset limits provided by the user. The electronic checkbook 100 may also be synced with software on a computer and connected to the computer for charging and syncing purposes.

What is claimed is:

1. An electronic checkbook for recording and monitoring transactions comprising:
a. a booklet of checks, where said checks are positioned at the lower half of the checkbook;
b. an electronic device, where said electronic device provides a means to store, record and scan receipts, to record transactions related to a plurality of accounts and to display data related to the transactions and the plurality accounts;
c. a power supply means, where said power supply means supplies power to the electronic device.

2. The electronic checkbook according to claim 1, where said means to scan receipts includes a pin scanner connected to the electronic device.

3. The electronic checkbook according to claim 2, where said electronic device includes a display, said display for displaying the results of a scanned document using the pin scanner.

4. The electronic checkbook according to claim 1, where the electronic device includes a statement display, where said statement display displays the information related to the plurality of accounts.

5. The electronic checkbook according to claim 1, where the electronic device includes at least one processor, memory and software to execute functions related to the electronic device.

6. The electronic checkbook according to claim 1, where said power supply means includes a battery.

7. The electronic checkbook according to claim 6, where said battery is a rechargeable battery.

8. The electronic checkbook according to claim 7, where said electronic device further includes a charging connector, where said charging connector provides a means to charge the battery via a AC connection.

9. The electronic checkbook according to claim 1, where the power supply means includes a charging connector, where said charging connector connects at least one of an AC outlet and a computer.

10. The electronic checkbook according to claim 10, where said charging connector also provides a means to sync data stored on memory in the electronic device with data store on memory in the computer.

11. The electronic checkbook according to claim 1, further comprising a series of input buttons, where said input buttons provide a means to designate the type of transaction being recorded and the associated account.
